(19) United States
(12) Patent Application Publication
(10) Pub. No.: US 2015/0187029 A1
(43) Pub. Date: Jul. 2, 2015

(54) METHOD AND APPARATUS FOR DETERMINING PARCEL BUILDING SIZE

(71) Applicant: UNDERBUILT, L.L.C., Los Angeles, CA (US)

(72) Inventor: Shawn Peterson, Los Angeles, CA (US)

(73) Assignee: UNDERBUILT, L.L.C., Los Angeles, CA (US)

(21) Appl. No.: 14/145,911

(22) Filed: Dec. 31, 2013

(51) Int. Cl. G06Q 50/16; G06Q 10/00

(52) U.S. Cl. CPC G06Q 50/16; G06Q 10/00

(57) ABSTRACT

A system for determining the maximum building size that may be constructed on a real property parcel includes at least a first database including applicable governmental regulations that affect building size within a specific locality, a second database including information concerning real property parcel size and location with the locality, a means for comparing information from the second database with information from the first database and a means for generating a report for a specific parcel of real property, the report including at least a calculation of the maximum size of a building that may be constructed on a parcel of real property, the calculation being based on information contained in the first and second databases.

This application claims the benefit of U.S. Provisional Application No. 61/688,350 filed on Jul. 5, 2012.

### FIELD OF THE INVENTION

The present invention relates generally to methods and systems for investigating allowable construction limitations relating to real estate parcels and, more particularly, to a computer-implemented method and system for collecting and storing real estate -related data, searching the collected data, and generating a report which identifies the maximum size of a building that may be constructed on the real estate parcel.

### BACKGROUND OF THE INVENTION

Owners of real property often desire to construct buildings and improvements that maximize the use of their property. There are many reasons for doing so.

Historically, building codes have been developed, adopted, implemented, and enforced to ensure public safety and more recently have addressed issues such as energy efficiency, water use and sustainability. These codes, and standards that are referenced in the codes, are primarily developed in the voluntary sector (e.g. non-regulatory sector) and then adopted and applied by Federal, state and local governments as building rules and regulations. These building rules and regulations must be satisfied by building designers, owners, manufacturers, contractors and others involved in the design, construction, commissioning or operation of any aspect of a building and its systems. As used herein, the terms building codes and regulations are used interchangeably and are each intended to include the body of criteria one must or is directed to follow in the design, construction, commissioning, operation and maintenance of buildings within a given locality.

One common restriction that is found in almost all building codes is the maximum allowable floor area for any building that may be constructed on a particular real estate parcel. In the United States this area is typically measured in units of square footage. However, other equivalent units may be used, such as square meters.

The maximum allowable size is generally not uniform for all real estate parcels in a given municipality. The size typically varies by the size of the parcel. Larger parcels allow for the construction of larger buildings. In addition, other factors may limit or constrain the size of the building. These include zoning regulations. Residential properties generally have different building limitations than commercial properties. Also, building setbacks and slope terrain may also limit the size of the build.

To obtain information about allowable building limitations and restrictions, abstractors, alternately known as searchers or examiners, seek out various official records in an effort to determine the existence and effect of governmental codes, statues or other limitations that might affect rights in the property. Such a search is usually performed manually at a local government repository, e.g., the county clerk's office.

A typical search process begins when a homeowner, architect or contractor desires to design a building to be located on a particular property. Alternatively, it may be desired to improve or add-on to an existing property. The title company then instructs one or more abstractors to begin a title search. For example, an abstractor will likely search the records of the local county clerk's office and courthouse, as well as the records of the local tax office. Other governmental sources may also be searched, depending on the location and type of property.

In order to determine a parcel build size, it is first necessary to compile information concerning the specific real estate parcels that are present within a given locality. Due to the manner in which most county clerks maintain their real estate records, a property search is generally performed by searching a party's name. All of the instruments filed with the county clerk having that particular name are then identified, resulting in a very large number of documents, particularly if the name is common. The searcher must then review each of the identified documents to determine which ones are relevant. This is, of course, dependent on the abstractor locating the hard copy record and/or microfilm reel containing the needed document.

It is also necessary to compile all relevant building codes and other governmental regulations that affect the ability to construct buildings on a specific parcel. If and when the needed document is located, the required information is generally abstracted off the document onto a “scratch pad. This process is widely used due to a general lack of adequate copying facilities within a county clerk's office, or the typical delay associated with such copying. It will be appreciated that such delays may involve occupied or broken copy machines, as well as bureaucratic delays if the copying is done by a government employee.

Thus, abstractors are hampered by the government's cumbersome and antiquated methods of storing records, as well as the lack of access to such records outside of normal government business hours. At best, it takes hours to manually search, locate, and review the data required to produce the report. The nature of this process also increases the likelihood of error. For example, the need to manually abstract the required information from an original document to a scratch pad can result in inaccuracies, misspellings or other such mistakes in the report. Once all the information is obtained, the abstractor generally compiles the information in a report. This can result from transcribing errors, to handwriting illegibly, or to lost or misplaced data sheets.

There is therefore a need in the art for a system for collecting, sorting and storing of selected real estate related data in a readily searchable mode, thereby allowing searches to be conducted when needed (not limited by the office hours of the government repository), to be conducted at a remote site, to be able to retrieve all identified records, to be able to readily obtain copies of any such record. There is a further need in the art for a system which is adapted to receive and integrate regular periodic updates from various disparate sources, e.g., county clerks' offices. Ideally, this system should be capable of monitoring the quality of the incoming data. There is also a need in the art for a system which provides an improved mode of searching records relating to building codes and governmental regulations that affecting a particular property. Finally, there is a need in the art for a system that facilitates the initial preparation of a build size report, while reducing the likelihood of error being subsequently introduced into the report.

Thus, it would be desirable to provide an accurate, efficient and cost effective method and system for generating reports for the ability to determine the maximum size of a building that may be built or constructed on a given parcel of real property.

### BRIEF DESCRIPTION OF THE DRAWINGS

The above described features and advantages of embodiments of the present invention will be more fully appreciated with reference to the accompanying Figures, in which:

FIG. 1 depicts block diagram showing the major elements of a system for implementing an embodiment of the present invention.

FIG. 2 depicts block diagram showing the major steps of the method of the present invention.

FIG. 3 depicts a typical report generated by the system of the present invention.

### DETAILED DESCRIPTION OF THE PREFERRED EMBODIMENT

The present invention provides a method and apparatus for determining parcel build size. In the following description, numerous specific details are set forth to provide a thorough understanding of the present invention. In other instances, well-known details have been omitted so as not to obscure the present invention unnecessarily. It will be appreciated, therefore, by one skilled in the art that the present invention may be practiced in a more general application where such advantages provided by this invention are desired.

According to the present invention, a protocol and software program are provided to assist those familiar with the codes standards, regulations and other building-related criteria relating to parcel building size. The method and apparatus (or, alternatively, the system) of the present invention allow one to automatically check a specific real estate parcel to determine how large of a building may be built on a given lot. In an alternative embodiment, the system and method of the present invention can be used to determine how much additional square footage may be added to an existing building on a lot.

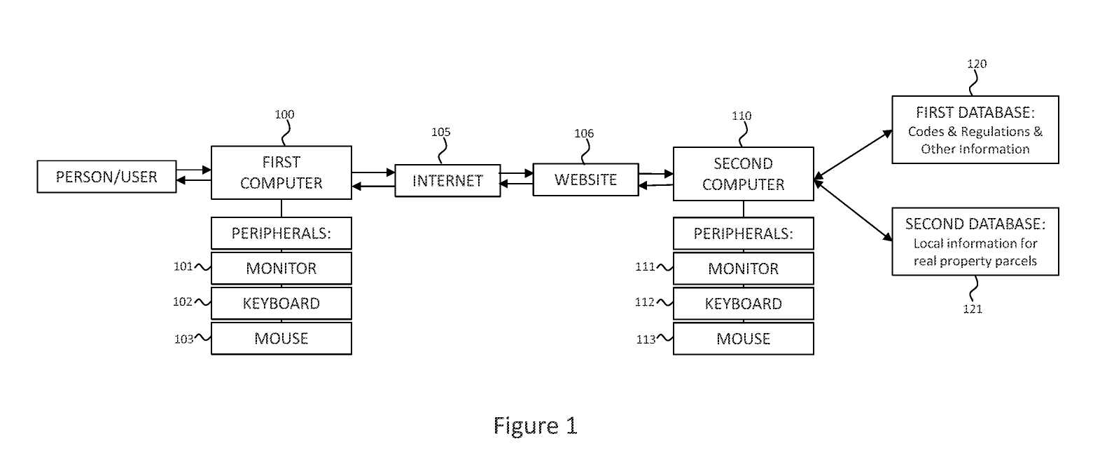

Referring first to FIG. 1, a system implementing an embodiment of the present invention is illustrated. The elements of the system include a first computer 100 wherein said first computer has input-output peripherals. In the illustrated embodiment, the peripherals include a monitor 101, keyboard 102 and a mouse or manually manipulated interface cursor control 103 that are connected to the first computer 100. In the preferred embodiment, the first computer illustrated is connected to the internet 105. However, in an alternative embodiment, the system can operate on a stand-alone, local system.

Referring again to FIG. 1, the first computer 100 is shown connected, via the internet 105, to a website 106. The website 106 is connected to a second computer 110 having input-output peripherals as illustrated 111, 112, 113. The second computer 110 contains a first database 120. The first database 120 includes a summary of relevant municipal building codes, state statutes and regulations and other governmental limitations that effect the size of a building that can be built within a given locality or municipality. The governmental restrictions may also include limitations to air and soil rights.

In addition, there may be other non-governmental restrictions that are placed in the first database 120. For example, a local homeowners association may place limits on the size of houses that can be built in a residential area. Other limits may include but are not limited to deed and neighborhood restrictions, and covenants, conditions and restrictions (CC&Rs). Alternatively, in a commercial setting, contractual agreements, or private easements can limit the size of offices or other business-related buildings. Such agreements may also include limitations based on air and soil rights.

Also contained in the second computer is a second database 121. The second database 121 includes information for real property parcels located within the locality of interest. This information will generally be taken from a county recorder's office. In addition, survey information can be included within database 121 to provide specific information (such as slope, gradient, etc.) about each parcel that might be relevant to building size. In an alternative embodiment, databases 120 and 121 can be combined into a single database.

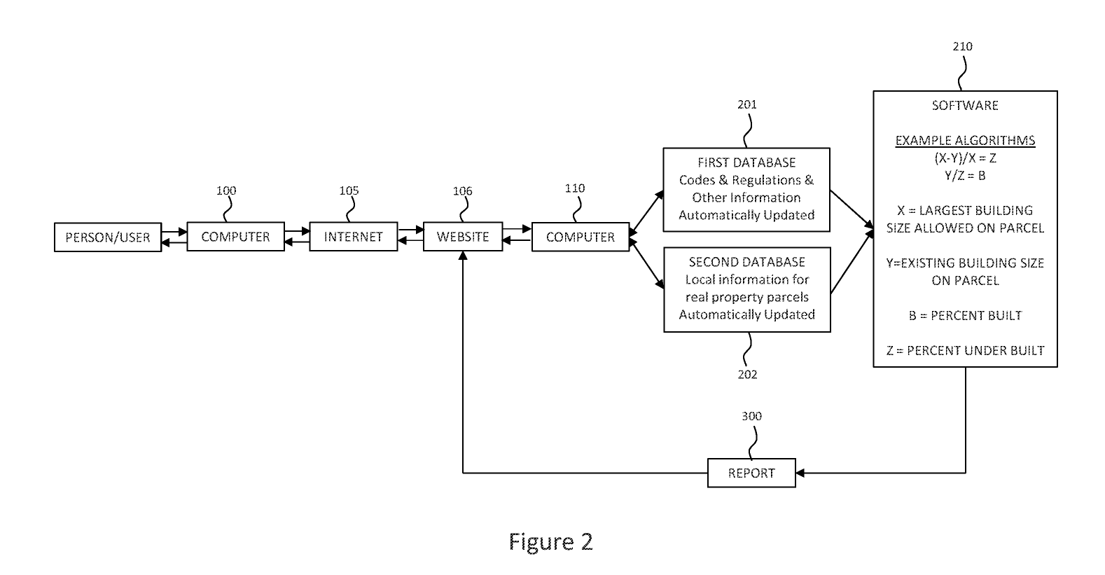

Referring next to FIG. 2, the method of implementing the present invention will now be described. As an initial step, the contents of the databases 120 and 121 are compiled. The process of compiling the database requires manually searching all applicable governmental regulations and other publicly-available information. This process is not automated, and requires human input which may be accomplished by the use of the second computer 110 or other inputting means. This is because relevant information, including building zones and codes are sometimes located on governmental records that are only accessible by physical inspection. In other instance, the building codes are deep within large PDF documents on city websites and it is very difficult to navigate to the information and understand the information required. Different residential and commercial properties in different zones, cities, counties require different data in order to correctly perform calculations to get the maximum buildable area. The system of the present invention collates data from multiple sources into the database.

As an optional embodiment, the system may include a means for automatically updating the databases 201 and 202 when building codes changes or information concerning parcel sizes (such as subdivisions) is recorded.

The database may also be accessed by a software 210 which the software 210 uses property information in the second database 202 and compares it to building codes and regulations in the first a database 201 to generate a report for the size of a building that can be built on the property. The specific computer codes and methods are not described herein, but will be well known to those of skill in the art.

A user visits a website 106 or application with a first computer 100 or mobile device. The user then either searches sale listings with reports 300 already available or selects the option to manually enter their property's information for a new report 300. In one embodiment, the system of the present invention selects the proper components from the databases 201 and 202, per property, and then performs the proper calculations to generate a report 300 dynamically. This allows the system to ensure that the reports are generated current data. In an alternative embodiment, the calculations are performed in advance for each property within a particular location and the report 300 is then stored in memory. This reduces the amount of time that might be needed to present the report to a user.

In this report 300 the user sees an overall comparison score given in percentage form. The user also sees how this comparison was generated, what city official supplied the information and the date acquired. The user can then have this report 300 sent to them or print it for their records. A user must select a property from a list or enter information for their property then choose to have a report 300 generated.

This report 300 may quickly answer the question, “What can I build and at what size on this property?” thereby saving users both time and money. They can then seek professional assistance in purchasing the property in question or if they own the property they can then call a professional to help them improve on the property.

In an alternate embodiment, the invention may produce a comparison parcel report showing the specific building types and sizes that are allowed on that parcel compared to what is currently in existence there.

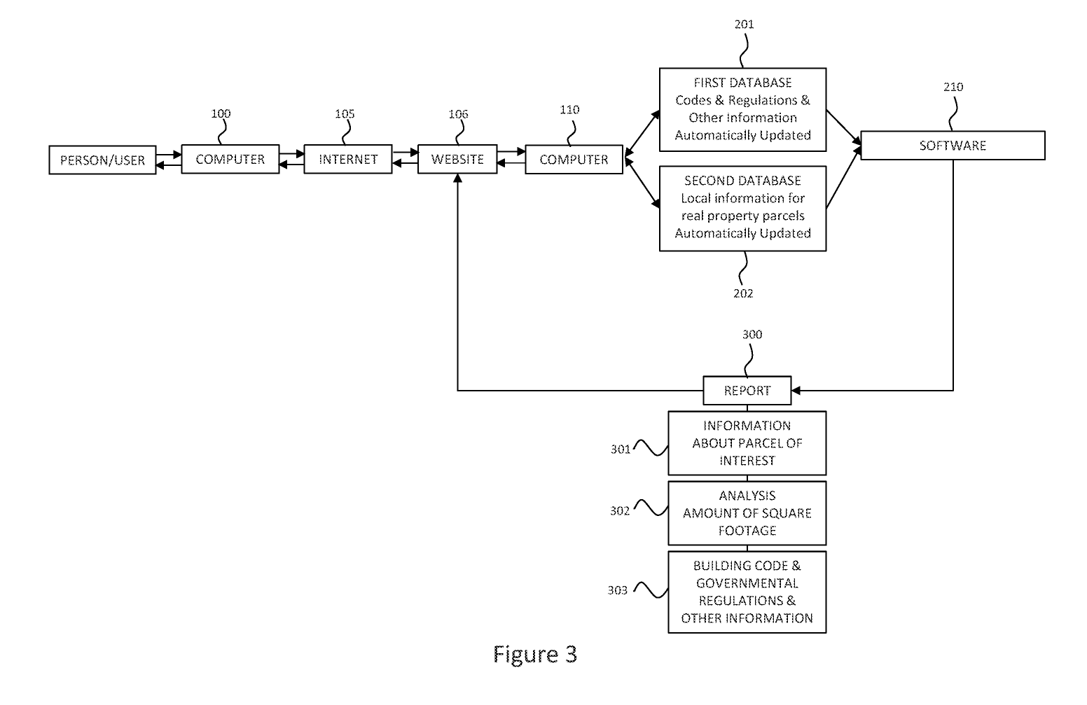

Referring next to FIG. 3, a typical report 300 generated by the system and method of the present invention is shown. The report 300 includes information 301 about the real estate parcel of interest. This information can include location information such as a street address or lot number. Other information about the parcel may include a description of terrain or slope conditions. Information about pre-existing structures on the property can also be included. This includes a description of existing buildings that may have been previously constructed. Of particular interest would be the size and amount of square footage of the existing buildings. In an alternative embodiment, the report would eliminate any reference to existing buildings. This would be useful when a property owner intends to construct an entirely new building on the property. The report may optionally include information about the value of the property and/or pre-existing buildings and tax assessments and payments.

Referring again to FIG. 3, the report will include an analysis 302 of the amount of square footage that can be legally built on the property. When a building already exists on the property, the report 300 will display the amount of square footage that can legally be added to the building, in accordance with existing codes and regulations. In an alternative embodiment, the report will display the maximum size of a building that can be constructed. This information is useful when a new building is desired to be constructed on the real estate parcel. Finally, the report 300 will include information 303 concerning the specific building codes or other governmental regulations that have an effect on the size of the building that may be constructed on the parcel of interest.

After the report 300 is generated, it can be used in a number of different ways. The report 300 can be a basis supporting an estimate of the value of the real property, because valuation often depends on the size of the building on a particular location. In another embodiment, the report can be used to assist an architect or contractor to design an addition to an existing structure that will increase or maximize the size of the building on the site.

A system and apparatus for determining parcel build size has been disclosed. Although the present invention has been described in terms of a preferred embodiment, it will be appreciated that various modifications and alterations might be made by those skilled in the art without departing from the spirit and scope of the invention. Therefore, the invention should be measured only in terms of the claims which follow.

What is claimed is:

1. A system for determining the maximum building size that may be constructed on a real property parcel, comprising:
a first database including applicable governmental regulations that affect building size within a specific locality;
a second database including information concerning real property parcel size and location with said locality;
means for comparing information from said second database with information from said first database;
means for generating a report for a specific parcel of real property, said report including at least a calculation of the maximum size of a building that may be constructed on a parcel of real property, said calculation being based on information contained in said first and second databases.

2. The method of claim 1 wherein said step of preparing a report is completed only in response to a user request.

3. The method of claim 1 further comprising the step of utilizing said report to create plans for building a structure on said parcel, said plans defining a structure having a size that is no larger than, or substantially equal to, a maximum size of a building that may be built on said property in accordance with building codes and governmental regulations.

4. A method for determining the maximum building size that may be constructed on a real property parcel, comprising:
compiling a first database including applicable limitations that affect building size within a specific locality, said compiling step being accomplished by at least searching governmental codes and regulations;
compiling a second database including information concerning real property parcel size and location with said locality, said compiling step;
receiving a query from a user, said query containing an identification of at least one specific parcel of real property, wherein information related to said specific parcel of real property is located within said second database;
preparing a report for said specific parcel of real property, said report including at least a calculation of the maximum size of a building that may be constructed on said parcel of real property, said preparing step being performed by comparing information contained in said first database with information in said second databases.

5. The method of claim 4 further comprising the step of constructing a building in accordance with said plans.

6. The method of claim 4 further comprising the step of constructing an addition to an existing building on said parcel in accordance with said plans.

7. A method for constructing a building on a real property parcel, comprising:
compiling a first database including applicable limitations that affect building size within a specific locality, said compiling step being accomplished by at least searching governmental codes and regulations;
compiling a second database including information concerning real property parcel size and location with said locality, said compiling step;
receiving a query from a user, said query containing an identification of at least one specific parcel of real property, wherein information related to said specific parcel of real property is located within said second database;
preparing a report for said specific parcel of real property, said report including at least a calculation of the maximum size of a building that may be constructed on said parcel of real property, said preparing step being performed by comparing information contained in said first database with information in said second databases;
utilizing said report to create plans for building a structure on said parcel, said plans defining a structure having a size that is no larger than, or substantially equal to, a maximum size of a building that may be built on said property in accordance with building codes and governmental regulations;
constructing said building in accordance with said plans.
